(19) United States
(12) Patent Application Publication
(10) Pub. No.: US 2023/0400298 A1
(43) Pub. Date: Dec. 14, 2023

(54) INTERNAL OXIDE LAYER THICKNESS ESTIMATION DEVICE, INTERNAL OXIDE LAYER THICKNESS ESTIMATION METHOD, AND PROGRAM

(71) Applicant: NIPPON STEEL CORPORATION, Tokyo (JP)

(72) Inventors: Tooru AKASHI, Tokyo (JP); Keita IKEDA, Tokyo (JP); Yasumitsu KONDO, Tokyo (JP); Naoki INOUE, Tokyo (JP); Akinobu MINAMI, Tokyo (JP)

(73) Assignee: NIPPON STEEL CORPORATION, Tokyo (JP)

(21) Appl. No.: 18/033,387

(22) PCT Filed: Nov. 2, 2021
(86) PCT No.: PCT/JP2021/040402

§ 371 Date: Apr. 24, 2023

(30) Foreign Application Priority Data
Nov. 6, 2020 (JP) 2020-185639

(51) Int. Cl. G01B 21/08

(52) U.S. Cl. CPC G01B 21/085

(57) ABSTRACT

This internal oxide layer thickness estimation device estimates a thickness of an internal oxide layer formed in a hot-rolled steel sheet. The internal oxide layer thickness estimation device includes: a first temperature definition unit that defines a temperature of a portion to be estimated, in which the thickness of the internal oxide layer is to be estimated, in the hot-rolled steel sheet; a second temperature definition unit that defines an internal oxidation starting temperature at which internal oxidation of the hot-rolled steel sheet starts; a cumulative temperature calculation unit that calculates a cumulative temperature on the basis of the temperatures defined by the first temperature definition unit and the second temperature definition unit and a predetermined period of time from an estimation start time at which estimation of the thickness of the internal oxide layer is started to an estimation evaluation time; a first correlation expression derivation unit that derives a first correlation expression indicating a correlation between the cumulative temperature calculated by the cumulative temperature calculation unit and an estimated value of the thickness of the internal oxide layer; and an internal oxide layer thickness estimation unit that estimates the thickness of the internal oxide layer on the basis of the first correlation expression.

### TECHNICAL FIELD OF THE INVENTION

The present invention relates to an internal oxide layer thickness estimation device, an internal oxide layer thickness estimation method, and a program. This application claims priority based on Japanese Patent Application No. 2020-185639 filed on Nov. 6, 2020, the content of which is incorporated herein by reference.

### RELATED ART

In many cases, hot-rolled steel sheets manufactured by hot rolling cast pieces are coiled and then cooled. In this cooling step, an internal oxide layer is formed in a base metal portion immediately below a scale layer. The internal oxide layer is a layer in which metal oxides are dispersed at grain boundaries and in crystal grains. The metal oxide is mainly composed of an oxide of an element (for example, Si, Mn, Al, Cr, or the like) that is less noble than iron. The scale layer is relatively easily removed by a pickling step after the cooling process. However, it is difficult to remove the internal oxide layer in the pickling step. Therefore, there is a problem that the excessive formation of the internal oxide layer significantly reduces the speed of the pickling step. In a steel material, such as high tensile strength steel (high-tensile steel), containing a large number of elements that are less noble than iron, the internal oxide layer is likely to be formed. Therefore, this problem is particularly remarkable. Therefore, a method for controlling an appropriate thickness of the internal oxide layer is required.

### PRIOR ART DOCUMENT

### Patent Document

[Patent Document 1] Japanese Unexamined Patent Application, First Publication No. 2013-103235

### Non-Patent Documents

[Non-Patent Document 1] Kobayashi et al., “Improvement of Formability in Cold Rolling of Hot Band for Over 980 MPa Grade High Tensile Strength Steel”, Iron and Steel, Vol100 (2014), No. 5, P616-624

### DISCLOSURE OF THE INVENTION

### Problems to be Solved by the Invention

It is widely accepted that the thickness of the scale layer follows a so-called parabolic law. This is based on the assumption that the thickness of the scale layer is proportional to the square root of time. Meanwhile, findings for the thickness of the internal oxide layer have been described in Non-Patent Document 1 and Patent Document 1. However, it was not possible to accurately estimate the thickness of the internal oxide layer on the basis of these findings.

Specifically, Non-Patent Document 1 discloses that there is a temperature (internal oxidation starting temperature Tcr) at which the generation of an internal oxide layer substantially starts, and that the internal oxide layer is not formed in a temperature range equal to or lower than the internal oxidation starting temperature. In addition, the thickness of the internal oxide layer is treated as being proportional to time. However, the thickness of the internal oxide layer is not simply proportional to time, which will be described in detail below.

Patent Document 1 discloses Expression A in which the thickness of the internal oxide layer is proportional to the square root of a value obtained by integrating an Arrhenius growth rate over time. However, the presence of the internal oxidation starting temperature is not reflected in Expression A, and the integration is performed until the temperature falls below the internal oxidation starting temperature to reach room temperature. Therefore, there is also a problem in the accuracy of estimation.

$$δ : \sqrt{{\int }_{tc}^{te} a exp ( - \frac{b}{T} ) dt} ( m ) \qquad ( A )$$

t: Time (second)
tc: Coiling start time (second)
te: Time until temperature reaches room temperature (second)
T: Absolute temperature (K)
a: 8 to 9×10⁻⁶
b: 1.5 to 2.5×10⁴

The invention has been made in view of the above problems, and an object of the invention is to provide an internal oxide layer thickness estimation device, an internal oxide layer thickness estimation method, and a program that can estimate a thickness of an internal oxide layer in a hot-rolled steel sheet with higher accuracy.

### Means for Solving the Problem

In order to solve the above-described problems, according to an aspect of the invention, there is provided an internal oxide layer thickness estimation device that estimates a thickness of an internal oxide layer formed in a hot-rolled steel sheet. The internal oxide layer thickness estimation device includes: a first temperature definition unit that defines a temperature of a portion to be estimated, in which the thickness of the internal oxide layer is to be estimated, in the hot-rolled steel sheet; a second temperature definition unit that defines an internal oxidation starting temperature at which internal oxidation of the hot-rolled steel sheet starts; a cumulative temperature calculation unit that calculates a cumulative temperature on the basis of the temperatures defined by the first temperature definition unit and the second temperature definition unit and a predetermined period of time from an estimation start time at which estimation of the thickness of the internal oxide layer is started to an estimation evaluation time; a first correlation expression derivation unit that derives a first correlation expression indicating a correlation between the cumulative temperature calculated by the cumulative temperature calculation unit and an estimated value of the thickness of the internal oxide layer; and an internal oxide layer thickness estimation unit that estimates the thickness of the internal oxide layer on the basis of the first correlation expression.

Here, the internal oxide layer may be formed when the hot-rolled steel sheet is cooled in a coiled state.

In addition, the cumulative temperature calculation unit may calculate the cumulative temperature on the basis of the following Expression (1).

S_{T}=∫ₜ₀^{t1}(T−Tcr)dt (1)

In Expression (1), S_{T} is the cumulative temperature, T is the temperature of the portion to be estimated, in which the thickness of the internal oxide layer is to be estimated, in the hot-rolled steel sheet, Tcr is the internal oxidation starting temperature at which the internal oxidation of the hot-rolled steel sheet starts, t0 is the estimation start time when the estimation of the thickness of the internal oxide layer is started, t1 is the estimation evaluation time, and T−Tcr is 0 in an integration interval where T−Tcr is equal to or less than 0.

In addition, the first correlation expression may be represented by any one or a combination of two or more of the following Expressions (2) to (4).

H=αS_{T}+H₀ (2)

H=βS_{T}^{1/2}+H₀ (3)

H=γS_{T}+δS_{T}²+H₀ (0≤S^{T}≤−γ/(2δ): a local maximum value of the thickness of the internal oxide layer at this time is Hm)

H=φ{S_{T}+γ/(2δ)}+Hm(S_{T}>−γ/(2δ)) (4)

In Expressions (2) to (4), H is the estimated value of the thickness of the internal oxide layer, α, β, γ, φ, and δ are constants, H₀ is an initial value of the thickness of the internal oxide layer, and S_{T} is the cumulative temperature and has a value of S_{T}≥0. In a case in which the first correlation expression is configured by Expression (4), in a range of the cumulative temperature after the local maximum value of the thickness of the internal oxide layer, the first correlation expression is set such that at least the estimated value of the thickness of the internal oxide layer is not decreased.

Further, in the case in which the first correlation expression is configured by Expression (4), the first correlation expression derivation unit may make the estimated value of the thickness of the internal oxide layer constant at the local maximum value in the range of the cumulative temperature after the local maximum value of the thickness of the internal oxide layer.

Furthermore, the second temperature definition unit may define the internal oxidation starting temperature on the basis of a correlation between the cumulative temperature and a measured value of the thickness of the internal oxide layer when the internal oxidation starting temperature is changed.

Moreover, the second temperature definition unit may change the internal oxidation starting temperature to derive a temperature-determining correlation expression indicating a correlation between the cumulative temperature and the estimated value of the thickness of the internal oxide layer and may define the internal oxidation starting temperature on the basis of a degree-of-freedom determination coefficient R² of the temperature-determining correlation expression.

In addition, the hot-rolled steel sheet may be coiled, and the estimation start time may be a coiling completion time at which the coiling of the hot-rolled steel sheet is completed.

Further, the internal oxide layer thickness estimation device may further include a second correlation expression derivation unit that derives a second correlation expression indicating a correlation between the cumulative temperature and a coiling completion temperature of the hot-rolled steel sheet.

According to another aspect of the invention, there is provided an internal oxide layer thickness estimation method that estimates a thickness of an internal oxide layer formed in a hot-rolled steel sheet. The internal oxide layer thickness estimation method includes: a first temperature definition step of defining a temperature of a portion to be estimated, in which the thickness of the internal oxide layer is to be estimated, in the hot-rolled steel sheet; a second temperature definition step of defining an internal oxidation starting temperature at which internal oxidation of the hot-rolled steel sheet starts; a cumulative temperature calculation step of calculating a cumulative temperature on the basis of the temperatures defined by the first temperature definition step and the second temperature definition step and a predetermined period of time from an estimation start time at which estimation of the thickness of the internal oxide layer is started to an estimation evaluation time; a first correlation expression derivation step of deriving a first correlation expression indicating a correlation between the cumulative temperature calculated by the cumulative temperature calculation step and an estimated value of the thickness of the internal oxide layer; and an internal oxide layer thickness estimation step of estimating the thickness of the internal oxide layer on the basis of the first correlation expression.

According to still another aspect of the invention, there is provided a program that causes a computer to estimate a thickness of an internal oxide layer formed in a hot-rolled steel sheet. The program causes the computer to function as: a first temperature definition unit that defines a temperature of a portion to be estimated, in which the thickness of the internal oxide layer is to be estimated, in the hot-rolled steel sheet; a second temperature definition unit that defines an internal oxidation starting temperature at which internal oxidation of the hot-rolled steel sheet starts; a cumulative temperature calculation unit that calculates a cumulative temperature on the basis of the temperatures defined by the first temperature definition unit and the second temperature definition unit and a predetermined period of time from an estimation start time at which estimation of the thickness of the internal oxide layer is started to an estimation evaluation time; a first correlation expression derivation unit that derives a first correlation expression indicating a correlation between the cumulative temperature calculated by the cumulative temperature calculation unit and an estimated value of the thickness of the internal oxide layer; and an internal oxide layer thickness estimation unit that estimates the thickness of the internal oxide layer on the basis of the first correlation expression.

### Effects of the Invention

According to the above-described aspects of the invention, the thickness of the internal oxide layer is estimated on the basis of the cumulative temperature having a very high correlation with the thickness of the internal oxide layer. Therefore, it is possible to estimate the thickness of the internal oxide layer with higher accuracy.

### BRIEF DESCRIPTION OF THE DRAWINGS

FIG. 1 is a graph showing a correlation between a measured value of a thickness of an internal oxide layer and a cumulative temperature.

FIG. 2 is a graph showing that the correlation between the measured value of the thickness of the internal oxide layer and the cumulative temperature fluctuates depending on an internal oxidation starting temperature Tcr.

FIG. 3A is a graph showing an example of a first correlation expression (model formula) indicating a correlation between an estimated value of the thickness of the internal oxide layer and the cumulative temperature.

FIG. 3B is a graph showing an example of the first correlation Expression (model formula) indicating the correlation between the estimated value of the thickness of the internal oxide layer and the cumulative temperature.

FIG. 4 is a graph showing an example of the first correlation expression (model formula) indicating the correlation between the estimated value of the thickness of the internal oxide layer and the cumulative temperature.

FIG. 5 is a graph showing an example of the first correlation expression (model formula) indicating the correlation between the estimated value of the thickness of the internal oxide layer and the cumulative temperature.

FIG. 6 is a graph showing a method of determining a coiling completion temperature of a hot-rolled steel sheet.

FIG. 7 is a functional block diagram showing a configuration of an internal oxide layer thickness estimation device according to this embodiment.

FIG. 8 is a flowchart showing a flow of a process of an internal oxide layer thickness estimation method according to this embodiment.

FIG. 9 is a diagram showing a hardware configuration of the internal oxide layer thickness estimation device according to this embodiment.

### EMBODIMENTS OF THE INVENTION

Hereinafter, preferred embodiments of the invention will be described in detail with reference to the accompanying drawings. The inventors thoroughly studied parameters having a high correlation with a thickness of an internal oxide layer in order to estimate the thickness of the internal oxide layer. As a result, the inventors found that a cumulative temperature described below had a very high correlation with the thickness of the internal oxide layer. An internal oxide layer thickness estimation device, an internal oxide layer thickness estimation method, and a program according to this embodiment are achieved on the basis of these findings.

<1. Type of Hot-Rolled Steel Sheet>

A hot-rolled steel sheet (in which the thickness of an internal oxide layer is estimated by this estimation method) to be subjected to the internal oxide layer thickness estimation method according to this embodiment is not particularly limited. Any hot-rolled steel sheet may be used as long as an internal oxide layer can be formed therein. The hot-rolled steel sheet may be, for example, alloy steel including metal that is less noble than iron (for example, Si, Mn, Al, or Cr or any combination thereof). The hot-rolled steel sheet may be, specifically, high tensile strength steel (high-tensile steel) or the like. In particular, the high-tensile steel is a preferable example of the object to which this embodiment is applied because the internal oxide layer is easily formed.

A thermal history of the hot-rolled steel sheet when the thickness of the internal oxide layer is estimated is not particularly limited. For example, the hot-rolled steel sheet is coiled and then cooled by any cooling method such as air cooling or water cooling (cooling step). In this cooling step, the internal oxide layer is formed immediately below a scale layer. In this case, the thermal history of the hot-rolled steel sheet follows a relatively simple cooling process. Of course, the thermal history of the hot-rolled steel sheet is not limited to this example. For example, the hot-rolled steel sheet may be cooled to a certain temperature in the cooling step after being coiled and then may be soaked or reheated for the purpose of annealing or the like. Further, the above-described cooling, annealing, and the like may be performed on the hot-rolled steel sheet in an uncoiled state in which the hot-rolled steel sheet is stretched into a flat sheet shape. Furthermore, the hot-rolled steel sheet may be cooled to a temperature that is equal to or lower than an internal oxidation starting temperature Tcr which will be described below and then may be reheated to a temperature that is equal to or higher than the internal oxidation starting temperature Tcr. That is, in the calculation of the cumulative temperature which will be described below, there may be an integration interval in which the temperature T of a portion to be estimated is equal to or lower than Tcr. In this integration interval, T−Tcr may be set to 0, which will be described below.

<2. Overall Configuration of Internal Oxide Layer Thickness Estimation Device>

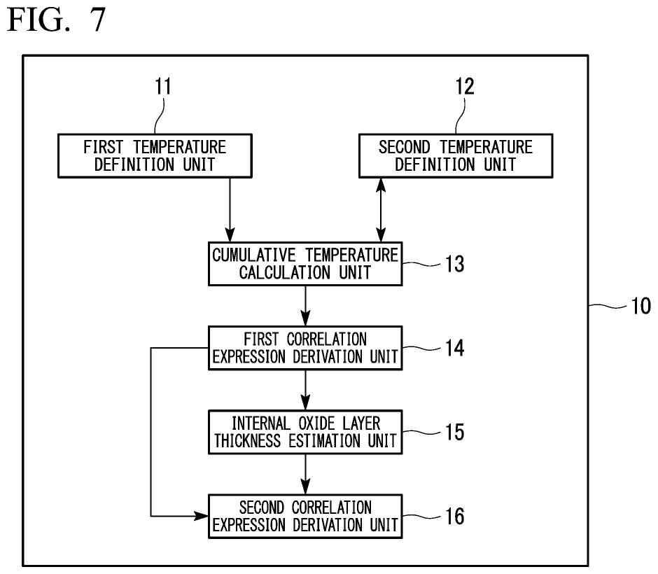

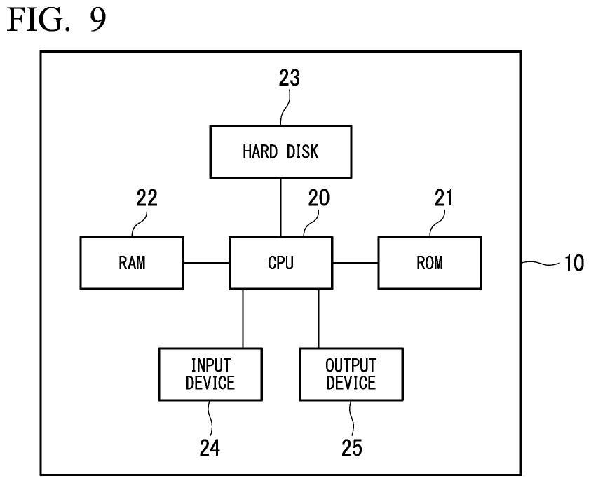

FIG. 7 is a functional block diagram showing the overall configuration of an internal oxide layer thickness estimation device 10 according to this embodiment. As shown in FIG. 7, the internal oxide layer thickness estimation device 10 includes a first temperature definition unit 11, a second temperature definition unit 12, a cumulative temperature calculation unit 13, a first correlation expression derivation unit 14, an internal oxide layer thickness estimation unit 15 and a second correlation expression derivation unit 16. The first temperature definition unit 11 defines the temperature of a portion to be estimated, in which the thickness of the internal oxide layer is to be estimated, in the hot-rolled steel sheet. The second temperature definition unit 12 defines an internal oxidation starting temperature at which the internal oxidation of the hot-rolled steel sheet starts. The cumulative temperature calculation unit 13 calculates the cumulative temperature on the basis of the temperature defined by the first temperature definition unit and the second temperature definition unit and a predetermined period of time from an estimation start time when the estimation of the thickness of the internal oxide layer is started to an estimation evaluation time. The first correlation expression derivation unit 14 derives a first correlation expression indicating the correlation between the cumulative temperature calculated by the cumulative temperature calculation unit and the estimated value of the thickness of the internal oxide layer. The internal oxide layer thickness estimation unit 15 estimates the thickness of the internal oxide layer on the basis of the first correlation expression. The second correlation expression derivation unit 16 derives a second correlation expression indicating the correlation between the coiling completion temperature and the cumulative temperature. In addition, each function will be described below together with a relational expression of the cumulative temperature. As shown in FIG. 9, the internal oxide layer thickness estimation device 10 includes a CPU 20, a ROM 21, a RAM 22, a hard disk 23, various input devices (for example, a keyboard and a mouse) 24, and various output devices (for example, a display) 25 as a hardware configuration. For example, a program that causes the internal oxide layer thickness estimation device 10 (computer) to function as the first temperature definition unit 11, the second temperature definition unit 12, the cumulative temperature calculation unit 13, the first correlation expression derivation unit 14, the internal oxide layer thickness estimation unit 15, and the second correlation expression derivation unit 16 is recorded on the ROM. The CPU reads and executes the program. The RAM serves as a work area of the CPU. The operator can input various types of information to the internal oxide layer thickness estimation device 10 using the input device. In addition, the internal oxide layer thickness estimation device 10 outputs various types of information to the output device. Hereinafter, for example, processes performed by each component and the cumulative temperature, which is an important parameter in this embodiment, will be described.

<3. Cumulative Temperature>

In summary, the internal oxide layer thickness estimation method according to this embodiment estimates the thickness of the internal oxide layer formed in the hot-rolled steel sheet on the basis of the cumulative temperature represented by the following Expression (1). The cumulative temperature represented by Expression (1) has a very high correlation with the thickness of the internal oxide layer, which will be described in detail below. Since the internal oxide layer thickness estimation device 10 according to this embodiment estimates the thickness of the internal oxide layer on the basis of the cumulative temperature, it is possible to estimate the thickness of the internal oxide layer with high accuracy.

S_{T}=∫ₜ₀^{t1}(T−Tcr)dt (1)

Therefore, the cumulative temperature is a very important parameter in this embodiment. Each parameter constituting the cumulative temperature will be described in detail.

T is the temperature of the portion to be estimated, in which the thickness of the internal oxide layer is to be estimated, in the hot-rolled steel sheet. The first temperature definition unit 11 defines the temperature of the portion to be estimated. Here, the scale layer is formed in the hot-rolled steel sheet. Therefore, here, it is assumed that the “temperature of the portion to be estimated” means the temperature of a base metal (base steel sheet) portion immediately below the scale layer. When the hot-rolled steel sheet is thin (for example, about 2 to 5 mm) and the temperature of the portion to be estimated is considered to be uniform in the sheet thickness direction, the temperature of the portion to be estimated may be the temperature of any portion in the sheet thickness direction or may be the temperature of the surface portion of the base metal. In a case in which the temperature fluctuates in the sheet thickness direction, it is preferable that the temperature of the portion to be estimated is the temperature of the surface of the base metal. The temperature of the portion to be estimated may be actually measured using a thermocouple or the like (in this case, the operator may input an output value of the thermocouple to the internal oxide layer thickness estimation device 10. The first temperature definition unit 11 recognizes the input temperature as the temperature of the portion to be estimated). For example, the temperature may be derived by a simulation (heat conduction calculation) typified by Non-Patent Document 1 (in this case, the first temperature definition unit 11 may perform the simulation). In this simulation, the thermal history of the hot-rolled steel sheet described above is taken into consideration.

Tcr is the internal oxidation starting temperature at which the internal oxidation of the hot-rolled steel sheet starts. Therefore, Expression (1) is a value obtained by integrating the difference between the temperature T of the portion to be estimated and the internal oxidation starting temperature Tcr over time. In this embodiment, it is considered that the internal oxide layer is formed (or grows) in a case in which the temperature of the portion to be estimated exceeds the internal oxidation starting temperature Tcr. Conversely, in a case in which the temperature of the portion to be estimated is equal to or lower than the internal oxidation starting temperature Tcr, the internal oxide layer is not formed (in a case in which the internal oxide layer has already been formed, the growth thereof stops). The internal oxidation starting temperature Tcr is a constant unique to the kind of steel. Therefore, an appropriate internal oxidation starting temperature Tcr is given to the steel material to which the invention is applied. The internal oxidation starting temperature Tcr may be set in a range of, for example, 200 to 1000° C. An appropriate value of Tcr may be set with reference to documents and the like. In addition, the value may be calculated independently by the following method. The second temperature definition unit 12 defines the internal oxidation starting temperature Tcr.

t0 is the estimation start time when the estimation of the thickness of the internal oxide layer is started. Here, the estimation start time may be determined by an external input, or a preset time may be set as the estimation start time. The estimation start time is set to any time in the process in which the internal oxide layer is assumed to be formed. Here, it is generally said that the internal oxide layer is formed in a state in which the scale layer is formed and the internal oxide layer is isolated from the outside air (atmosphere including oxygen). For example, when the coiled hot-rolled steel sheet (hereinafter, the hot-rolled steel sheet in this state is also simply referred to as a “coil”) is cooled, the scale layer is formed on each portion to be measured in the hot-rolled steel sheet, and the portion to be measured is isolated from the outside air. Therefore, it is considered that the internal oxide layer is formed in a coil cooling step. Then, the coil cooling step is started from the coiling completion time of the hot-rolled steel sheet. Therefore, the estimation start time t0 may be regarded as the coiling completion time of the hot-rolled steel sheet. Of course, the estimation start time t0 may be set to any time during the cooling step. In a case in which annealing or the like is performed during the cooling step, the estimation start time t0 may be set to a time period for which the annealing or the like is performed. For example, an annealing start time (the time when the portion to be estimated in the hot-rolled steel sheet reaches an inlet of an annealing furnace) may be set as the estimation start time t0, or a time in the middle of annealing may be set as the estimation start time to. In addition, as described above, in the cooling step, there may be an integration interval in which the temperature T of the portion to be estimated is lower than the internal oxidation starting temperature Tcr. In this case, for example, the portion to be estimated is cooled to the internal oxidation starting temperature Tcr or lower during the cooling step, and the portion to be estimated is reheated to the internal oxidation starting temperature Tcr or higher by the annealing.

t1 is the estimation evaluation time. Here, the estimation evaluation time may be determined by an external input, or a preset time may be set as the estimation evaluation time. Therefore, in this embodiment, it can be said that the thickness of the internal oxide layer at the estimation evaluation time t1 is estimated. The estimation evaluation time t1 is set to a time after the estimation start time t0. For example, any time during the coil cooling step may be set as the estimation evaluation time t1. Specifically, in a case in which annealing or the like is performed during the coil cooling step, the time when the annealing ends (the time when the portion to be estimated in the hot-rolled steel sheet reaches an outlet of the annealing furnace) may be set as the estimation evaluation time t1, or a time during the annealing may be set as the estimation evaluation time t1. Furthermore, any time during the cooling step after the annealing ends may be set as the estimation evaluation time t1. In this case, the time when the temperature T of the portion to be estimated finally reaches the internal oxidation starting temperature Tcr (after all of the above-described annealing and the like are performed) in the coil cooling step may be set as the estimation evaluation time t1. A time thereafter (that is, the time when the temperature T of the portion to be estimated is further cooled) may be set as the estimation evaluation time t1. As described above, in an integration interval after the temperature T of the portion to be estimated reaches the internal oxidation starting temperature Tcr, T−Tcr is equal to or less than 0. However, since T−Tcr is 0 in this integration interval, there is no effect on the accuracy of estimation.

In the calculation of the cumulative temperature, the temperature T of the portion to be measured may be actually measured or may be calculated by a simulation considering the thermal history of the hot-rolled steel sheet. In the former case, the operator may input the measured value to the internal oxide layer thickness estimation device 1. In the latter case, the first temperature definition unit 12 or a simulation unit (not shown) may simulate (estimate) the temperature T of the portion to be measured. In a case in which T−Tcr is equal to or less than 0 in any of the integration intervals, T−Tcr is set to 0 in the integration interval. In addition, in the integration operation, the integration interval (t0 to t1) may be divided into minute intervals Δt, and the discrete values of the cumulative temperatures in each interval Δt may be summed to calculate the cumulative temperature. The cumulative temperature calculation unit 13 calculates the cumulative temperature on the basis of the temperature defined by the first temperature definition unit 11 and the second temperature definition unit 12 and the above-described Expression (1). The operator may input t0 and t1 to the internal oxide layer thickness estimation device 1. The cumulative temperature calculation unit 13 recognizes the input values as t0 and t1 in Expression (1). Alternatively, t0 and t1 may be preset as specified values.

<4. Method for Determining Tcr>

The second temperature definition unit 12 may determine (define) the internal oxidation starting temperature Tcr using the following method. That is, the internal oxidation starting temperature Tcr may be determined, for example, on the basis of the correlation between the cumulative temperature and the measured value of the thickness of the internal oxide layer when the internal oxidation starting temperature Tcr is changed. For example, the internal oxidation starting temperature Tcr may be determined such that the correlation between the cumulative temperature and the measured value of the thickness of the internal oxide layer is the highest.

In a case in which the internal oxidation starting temperature Tcr is calculated, the second temperature definition unit 12 and the cumulative temperature calculation unit 13 perform, for example, the following process. First, the cumulative temperature calculation unit 13 sets the internal oxidation starting temperature Tcr to any value (for example, any value in a range of 200° C. to 1000° C.). Then, the portions to be measured are set at a plurality of positions on the surface of the hot-rolled steel sheet, and the cumulative temperatures of these portions to be measured are calculated on the basis of the above-described Expression (1). A specific calculation method is as described above. The portion to be measured may be set by the cumulative temperature calculation unit 13 or by the operator. In the former case, the internal oxide layer thickness estimation device 1 may display the portion to be measured on a display or the like. In the latter case, the operator may input the portion to be measured to the internal oxide layer thickness estimation device 1. The setting of the portion to be measured may be performed for the total length of the hot-rolled steel sheet in a rolling direction and the total width of the hot-rolled steel sheet in the sheet width direction or may be performed for a part of the total length and the total width. In an example described below, the portion to be measured is set for the total length and the total width. In addition, it is preferable that the portion to be measured is set in a sheet width center quarter portion. The reason is that the cumulative temperature in the sheet width center quarter portion has a high correlation with the measured value of the thickness of the internal oxide layer, which will be described below. Here, the sheet width center quarter portion means a region in a range from the center (center portion) of the hot-rolled steel sheet in the sheet width direction to portions (quarter portions) which are ¼ of the sheet width away from the center toward both ends in the sheet width direction (that is, a region interposed between a quarter portion close to one end portion in the width direction and a quarter portion close to the other end portion).

On the other hand, the operator actually measures the thickness of the internal oxide layer in the portion to be measured at the estimation evaluation time t1 and inputs the thickness to the internal oxide layer thickness estimation device 1. The thickness of the internal oxide layer is measured, for example, by cutting the hot-rolled steel sheet in parallel in the thickness direction, performing nital etching on a cut surface, and then observing the cut surface with a scanning electron microscope (SEM) or the like. In a region in which the internal oxide layer is formed, a metal oxide (grain boundary oxide) that is present at a grain boundary and a metal oxide (intragranular oxide) that is present within a crystal grain are observed. A region in which these oxides are observed may be determined to be the internal oxide layer. In addition, the thickness of the internal oxide layer may be measured at several points in the portion to be measured, and an average value thereof may be used as the thickness of the internal oxide layer in the portion to be measured. In this way, the cumulative temperature and the measured value of the thickness of the internal oxide layer are obtained for the plurality of portions to be measured. In addition, this test may be performed as an offline test.

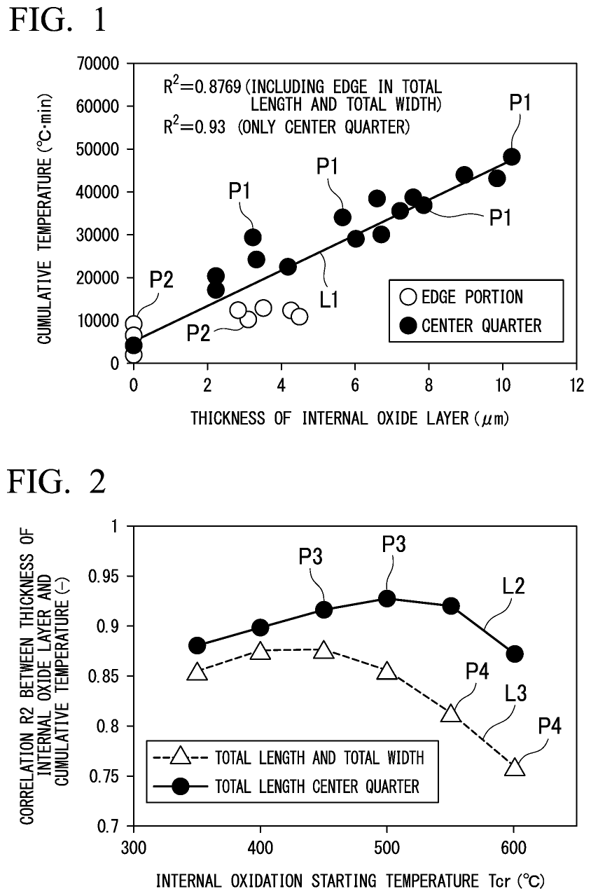

Then, the cumulative temperature calculation unit 13 plots the obtained cumulative temperature and the obtained measured value of the thickness of the internal oxide layer as measurement points on the xy plane having the cumulative temperature and the thickness of the internal oxide layer as the x-axis and the y-axis. An example is shown in FIG. 1. In FIG. 1, the horizontal axis indicates the thickness (μm) of the internal oxide layer, and the vertical axis indicates the cumulative temperature (° C.·min). In this example, the internal oxidation starting temperature Ter is 500° C. Points P1 and P2 indicate the cumulative temperature and the measured value of the thickness of the internal oxide layer for each portion to be measured. The point P1 indicates the value of the portion to be measured set in the sheet width center quarter portion of the hot-rolled steel sheet, and the point P2 indicates the value of the portion to be measured set in the edge portion (end portion) of the hot-rolled steel sheet in the sheet width direction.

Then, the cumulative temperature calculation unit 13 performs regression analysis on a plurality of measurement points to calculate an approximate expression (temperature-determining correlation expression) of these measurement points. The regression analysis may be, for example, simple regression analysis using a least-square method or may be multiple regression analysis. Here, it is preferable that the portion to be measured is set in the sheet width center quarter portion. This is because the cumulative temperature and the measured value of the thickness of the internal oxide layer in the sheet width center quarter portion have a high correlation. Furthermore, the internal oxide layer is likely to be formed particularly thickly in the sheet width center quarter portion, particularly, in the center portion. In this respect, it is preferable that the portion to be measured is set in the sheet width center quarter portion. In the example shown in FIG. 1, simple regression analysis is performed on the measurement point P1 (sheet width center quarter portion) to obtain a graph L1 (temperature-determining correlation expression). A degree-of-freedom determination coefficient R² of the graph L1 is 0.93. In the example shown in FIG. 1, in a case in which regression analysis is collectively performed on groups of the measurement points P1 and P2 (edge portion), the degree-of-freedom determination coefficient R² of the temperature-determining correlation expression is approximately 0.88. In the edge portion, a decrease in temperature is more remarkable than that in the sheet width center quarter portion, and unevenness is also larger than that in the sheet width center quarter portion. Therefore, in the edge portion, it is considered that the correlation between the cumulative temperature and the measured value of the thickness of the internal oxide layer is slightly low. That is, in a case in which the regression analysis is performed including the cumulative temperature of the edge portion, the degree-of-freedom determination coefficient R² of the temperature-determining correlation expression is slightly small.

Then, the second temperature definition unit 12 determines the internal oxidation starting temperature Tcr on the basis of the correlation between the cumulative temperature and the measured value of the thickness of the internal oxide layer when the internal oxidation starting temperature Tcr is changed. For example, the cumulative temperature calculation unit 13 derives the above-described temperature-determining correlation expression, using various different values of the internal oxidation starting temperature Tcr, and calculates each degree-of-freedom determination coefficient R². Then, the second temperature definition unit 12 selects the internal oxidation starting temperature Tcr when the degree-of-freedom determination coefficient R² of the temperature-determining correlation expression has the largest value (that is, the correlation between the cumulative temperature and the measured value of the thickness of the internal oxide layer is the highest).

FIG. 2 shows a specific example of the above and is a graph showing that the degree-of-freedom determination coefficient R² (that is, the correlation between the cumulative temperature and the measured value of the thickness of the internal oxide layer) of the temperature-determining correlation expression fluctuates depending on the internal oxidation starting temperature Tcr. In FIG. 2, the horizontal axis indicates the internal oxidation starting temperature Tcr(° C.), and the vertical axis indicates the degree-of-freedom determination coefficient R² of the temperature-determining correlation expression. Groups of plotted points P3 and P4 are points corresponding to the internal oxidation starting temperature Tcr and the degree-of-freedom determination coefficient R² of the temperature-determining correlation expression, and graphs L2 and L3 are curve graphs connecting the points P3 and P4, respectively. However, the point P3 indicates the degree-of-freedom determination coefficient R² of the temperature-determining correlation expression obtained by performing regression analysis on the cumulative temperature in the sheet width center quarter portion (the sheet width center quarter portion in the total length), and the point P4 indicates the degree-of-freedom determination coefficient R² of the temperature-determining correlation expression obtained by performing regression analysis on the cumulative temperatures in the sheet width center quarter portion and the edge portion (the total length and the total width). As can be clearly seen from FIG. 2, the degree-of-freedom determination coefficient R² indicated by the point P3 is larger than the degree-of-freedom determination coefficient R² indicated by the point P4. Therefore, the cumulative temperature in the sheet width center quarter portion has a high correlation with the measured value of the thickness of the internal oxide layer.

Both the graphs L2 and L3 have a peak. The graph L2 has a peak at an internal oxidation starting temperature Tcr of 500° C., and the graph L3 has a peak at an internal oxidation starting temperature Tcr of 450° C. The temperature of the edge portion is lower than the temperature of the sheet width center quarter portion, and unevenness is also large. Therefore, it is considered that this tendency appears. In any case, the peak of the graph L3 is lower than the peak of the graph L2. Therefore, as can be seen from the example shown in FIG. 2, it is preferable to set the internal oxidation starting temperature Tcr to 500° C.

<5. Derivation of First Correlation Expression>

Then, the first correlation expression derivation unit 14 derives the first correlation expression which will be described below. The gist of an internal oxide layer thickness estimation step according to this embodiment is that the thickness of the internal oxide layer formed in the hot-rolled steel sheet is estimated on the basis of the cumulative temperature represented by the above-described Expression (1). As a specific estimation method, an estimation method using the first correlation expression (model formula) indicating the correlation between the estimated value of the thickness of the internal oxide layer and the cumulative temperature is given. Therefore, the first correlation expression is an important expression for estimating the thickness of the internal oxide layer.

The first correlation expression derivation unit 14 derives the first correlation expression indicating the correlation between the cumulative temperature calculated by the cumulative temperature calculation unit 13 and the estimated value of the thickness of the internal oxide layer. The first correlation expression may be, for example, any one or a combination of two or more of Expressions (2) to (4) having the following format.

H=αS_{T}+H₀ (2)

H=βS_{T}^{1/2}+H₀ (3)

H=γS_{T}+δS_{T}²+H₀ (0≤S_{T}≤−γ/(2δ): a local maximum value of the thickness of the internal oxide layer at this time is Hm)

H=φ{S_{T}+γ/(2δ)}+Hm (S_{T}>−γ/(2δ)) (4)

In Expressions (2) to (4), H is the estimated value of the thickness of the internal oxide layer at the estimation evaluation time, and S_{T} is the cumulative temperature and has a value of S_{T}≥0. α, β, γ, φ, and δ are constants, and H₀ is an initial value of the thickness of the internal oxide layer.

Here, the initial value H₀ of the thickness of the internal oxide layer means the thickness of the internal oxide layer at the estimation start time t0. The initial value H₀ of the thickness of the internal oxide layer can be measured by rapidly cooling the hot-rolled steel sheet to the internal oxidation starting temperature Tcr or lower at the estimation start time t0 and then observing the cross section. This process may be performed by the operator. When it is clear that the internal oxide layer is not formed at the estimation start time to, this measurement may not be performed, and the initial value H₀ may be set to 0.

The parameters α, β, γ, and δ in the correlation expression are regression constants. The first correlation expression derivation unit 14 may determine the parameters using regression analysis on the basis of a plurality of sets of measured data of S_{T} and H (S_{T} is calculated by the cumulative temperature calculation unit 13 and H is actually measured by the operator).

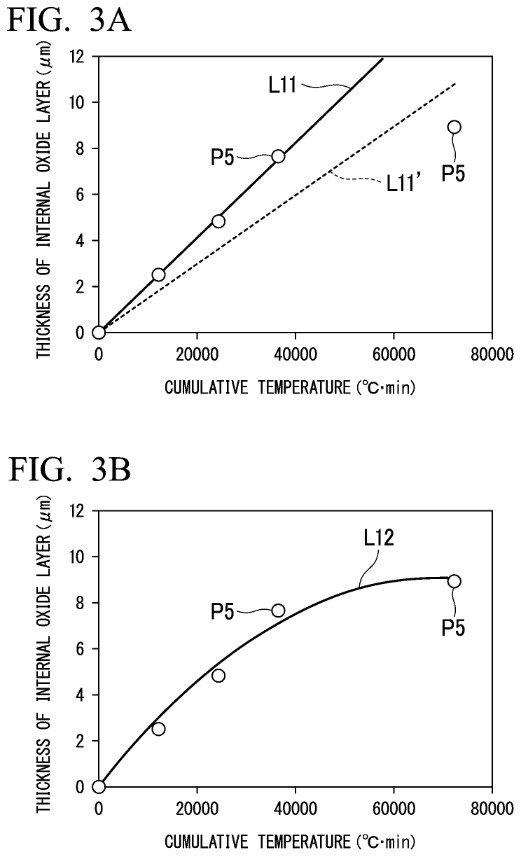

FIGS. 3A and 3B show examples of the first correlation expression. In FIGS. 3A and 3B, the horizontal axis indicates the cumulative temperature (° C.·min), and the vertical axis indicates the thickness (μm) of the internal oxide layer. A point P5 indicates the cumulative temperature and the measured value of the thickness of the internal oxide layer at the estimation evaluation time in each portion to be measured. Graphs L11 and L11′ indicate the first correlation expression configured by Expression (2) (L11: α=2.1×10⁻⁴, H₀=0, R²=0.9985, L11′: α=0.0001, H₀=0, R²=0.7998). Specifically, the graph L11 is a graph obtained by performing regression analysis on the point P5 at a cumulative temperature of 40,000° C.·min or less, and the graph L11′ is a graph obtained by performing regression analysis on all of the points P5. A graph L12 indicates the first correlation Expression (γ=2.686E-04, δ=−1.982E-09, H₀=0, R²=0.99) configured by Expression (4). Here, H₀=0 is set in each case. Further, the correlation expression is described here, using a cumulative temperature of 40,000° C.·min as a starting point. However, this is merely an example, and a method for determining the correlation expression is not limited to this example.

In the example shown in FIG. 3A, the graph L11 and the point P5 are sufficiently close to each other when the cumulative temperature is equal to or lower than 40,000° C.·min. Therefore, the thickness of the internal oxide layer can be estimated with sufficient accuracy by the graph L11. However, when the cumulative temperature exceeds 40,000° C.·min, an increase in the thickness of the internal oxide layer slows down. Therefore, the graph L11′ and the point P5 deviate slightly (therefore, R² is slightly deceased). On the other hand, as shown in FIG. 3B, the graph L12 and the point P5 are close to each other in this range. Therefore, for example, when the cumulative temperature is equal to or lower than 40,000° C.·min, the first correlation expression is configured by Expression (2). In a case in which the cumulative temperature exceeds 40,000° C.·min (that is, in a case in which it is desired to estimate the thickness of the internal oxide layer in a wider cumulative temperature range), the first correlation expression may be configured by Expression (4). In addition, in a case in which the cumulative temperature exceeds 40,000° C.·min, the graph of Expression (3) is also close to the point P5, which is not shown in FIG. 3B. Therefore, in a case in which the cumulative temperature exceeds 40,000° C.·min, the first correlation expression may be configured by Expression (3). Alternatively, since R² in Expression (4) is large in the entire range of the cumulative temperature (=0.99), the first correlation expression may be configured by Expression (4) in the entire range of the cumulative temperature. Since the number of parameters is large in Expression (4), Expression (4) can estimate the thickness of the internal oxide layer with higher accuracy than Expression (2) or Expression (3).

In addition, since 6 in Expression (4) has a negative value, Expression (4) has a local maximum value (Hm) with respect to the estimated value of the thickness of the internal oxide layer. In a case in which the thickness of the internal oxide layer is defined by H=γS_{T}+δS_{T}²+H₀ in the entire range of the cumulative temperature in Expression (4), the estimated value of the thickness of the internal oxide layer starts to decrease in the range of the cumulative temperature after the local maximum value. This does not fit the reality. Therefore, as shown in Expression (4), in the range of the cumulative temperature after the local maximum value (S_{T}>−γ/(2δ)), the estimated value of the thickness of the internal oxide layer may be constant at the local maximum value (in this case, φ=0 at H=φ{S_{T}+γ/(2δ)}+Hm).

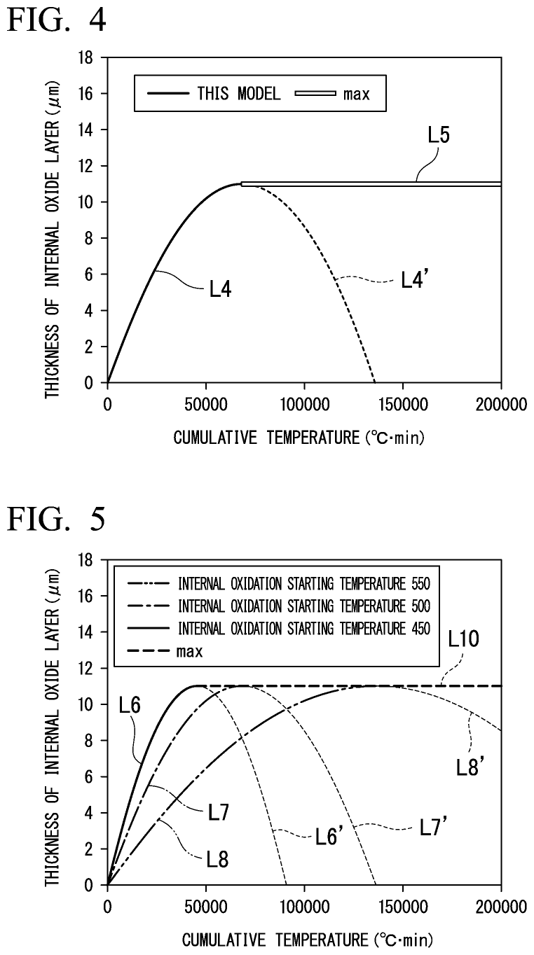

An example is shown in FIG. 4. In FIG. 4, the horizontal axis indicates the cumulative temperature (° C.·min), and the vertical axis indicates the thickness of the internal oxide layer. Graphs L4 and L5 indicate the first correlation expression configured by Expression (4). The graph L4 corresponds to a range (0≤S_{T}≤−γ/(2δ)) before the local maximum value, and the graph L5 corresponds to a range (S_{T}>−γ(2δ)) after the local maximum value. The graph L5 indicates the first correlation expression that is a constant value at the local maximum value (that is, φ=0 at H=φ{S_{T}+γ/(2δ)}+Hm). In this example, in the range of the cumulative temperature before the local maximum value, the first correlation expression is configured by H=γS_{T}+δS_{T}²+H₀ (graph L4) in Expression (4). In the range of the cumulative temperature after the local maximum value, the estimated value of the thickness of the internal oxide layer is constant at the local maximum value (graph L5). In the case in which the thickness of the internal oxide layer is defined by H=γS_{T}+δS_{T}²+H₀ in the entire range of the cumulative temperature in Expression (4), the thickness of the internal oxide layer is represented by a graph L4′ in the range of the cumulative temperature after the local maximum value. This does not fit the reality. As shown in FIGS. 3A and 3B, when the cumulative temperature increases, an increase in the measured value of the thickness of the internal oxide layer slows down. Finally, the measured value is a substantially constant value. Therefore, even when the estimated value of the thickness of the internal oxide layer is constant at the local maximum value in the range of the cumulative temperature after the local maximum value, it is possible to estimate the thickness of the internal oxide layer sufficient accuracy. In addition, the process after the local maximum value is not limited to the above-described example. For example, the first correlation expression derivation unit 14 may slightly increase the thickness of the internal oxide layer by setting φ>0 at H=φ{S_{T}±γ/(2δ)}+Hm after the local maximum value. Alternatively, the first correlation expression derivation unit 14 may set the first correlation expression using Expression (2) or the like after the local maximum value, instead of Expression (4). That is, the first correlation expression derivation unit 14 may set the first correlation expression such that at least the estimated value of the thickness of the internal oxide layer does not decrease.

FIG. 5 shows the same example as in FIG. 4. However, FIG. 5 also shows a change in the behavior of the first correlation expression when the internal oxidation starting temperature Tcr is changed. In FIG. 5, the horizontal axis indicates the cumulative temperature (° C.·min), and the vertical axis indicates the thickness (μm) of the internal oxide layer. Graphs L6 to L8 and L10 indicate the first correlation expression configured by Expression (4). The graph L10 indicates the first correlation expression that is a constant value at the local maximum value (that is, φ=0). In addition, in a case in which the thickness of the internal oxide layer is defined by H=γS_{T}+δS_{T}²+H₀ in the entire range of the cumulative temperature in Expression (4), the thickness of the internal oxide layer is represented by graphs L6′ to L8′ in the range of the cumulative temperature after the local maximum value. The internal oxidation starting temperature Tcr when the graphs L6 and L6′ are calculated is 450° C. The internal oxidation starting temperature Tcr when the graphs L7 and LT are calculated is 500° C. The internal oxidation starting temperature Tcr when the graphs L8 and L8′ are calculated is 550° C. The graphs L6 to L8 correspond to a range before the local maximum value, and the graph L10 corresponds to a range after the local maximum value. In any of the examples, the first correlation expression derivation unit 14 sets, as the first correlation expression, H=γS_{T}+δS_{T}²+H₀ (graphs L6 to L8) in Expression (4) in the range of the cumulative temperature before the local maximum value and makes the estimated value of the thickness of the internal oxide layer constant at the local maximum value in the range of the cumulative temperature after the local maximum value (graph L10). Here, as the internal oxidation starting temperature Tcr decreases, the slope of the graph increases rapidly. Further, the local maximum value is almost constant regardless of the internal oxidation starting temperature Ter. However, it can be considered that the maximum value changes depending on the kind of steel and thus the value is constant or increases slightly after reaching the local maximum value (that is, φ>0 at H=φ{S_{T}+γ/(2δ)}+Hm). In this graph, the value is constant (φ=0). What kind of internal oxidation starting temperature Tcr is suitable may be determined according to the above-described method for determining the internal oxidation starting temperature Tcr.

<6. Internal Oxide Layer Thickness Estimation Step>

After the first correlation expression is derived from the above-described step, the internal oxide layer thickness estimation unit 15 can estimate the thickness of the internal oxide layer on the basis of the first correlation expression. For example, first, the cumulative temperature calculation unit 13 measures the cumulative temperature of a portion, in which the thickness of the internal oxide layer is to be known, using the above-described method. Then, the internal oxide layer thickness estimation unit 15 can apply this cumulative temperature to the first correlation expression to estimate the thickness of the internal oxide layer in the portion. As shown in FIGS. 3A and 3B, there is a high correlation between the cumulative temperature and the measured value of the thickness of the internal oxide layer, and the degree-of-freedom determination coefficient R² of the first correlation expression is also large. Therefore, it is possible to estimate the thickness of the internal oxide layer with high accuracy on the basis of the first correlation expression.

In addition, the parameters fluctuate depending on the type (for example, chemical composition) and thermal history of the hot-rolled steel sheet. Therefore, it is preferable to derive the first correlation expression according to the type (for example, chemical composition) and thermal history of the hot-rolled steel sheet.

<7. Method for Determining Coiling Completion Temperature of Hot-Rolled Steel Sheet>

It is possible to determine the coiling completion temperature of the hot-rolled steel sheet using the above-described internal oxide layer thickness estimation method. Hereinafter, a method for determining the coiling completion temperature of the hot-rolled steel sheet using the internal oxide layer thickness estimation method will be described. In addition, in the determination method, it is premised that the hot-rolled steel sheet is coiled.

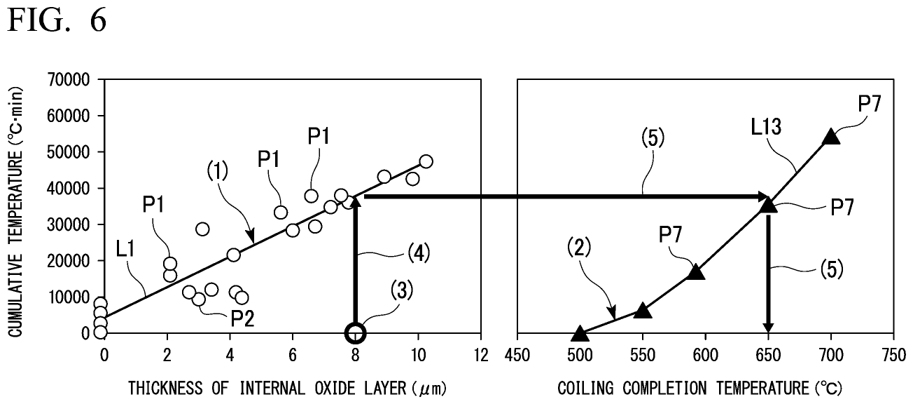

First, (1) the first correlation expression derivation unit 14 derives the first correlation expression on the basis of the thermal history after the coiling is completed. Here, the estimation start time t0 may be a coiling completion time. A specific derivation method is as described above. (2) Meanwhile, the second correlation expression derivation unit 16 derives the second correlation expression indicating the correlation between the coiling completion temperature and the cumulative temperature. The second correlation expression is an expression indicating the correlation between the cumulative temperature calculated by the cumulative temperature calculation unit 13 and the coiling completion temperature. Here, a portion in which the cumulative temperature is calculated is not particularly limited. The cumulative temperature may be calculated in a center portion in which the internal oxide layer is likely to be formed particularly thickly. That is, the cumulative temperature may be calculated at any one point of the center portion, or the cumulative temperature may be measured at a plurality of points of the center portion and an average value of the measured values may be used. Specifically, the second correlation expression derivation unit 16 changes the coiling completion temperature to several conditions (five conditions in a right figure of FIG. 6), and the cumulative temperature calculation unit 13 calculates the cumulative temperature corresponding to each coiling completion temperature. The second correlation expression derivation unit 16 formulates (in this embodiment, linearizes) the relationship between the coiling completion temperature and the cumulative temperature.

The second correlation expression derivation unit 16 may display the derived first and second correlation expressions in comparison with each other. An example thereof is shown in FIG. 6. A left figure of FIG. 6 shows the first correlation expression, and the right figure shows the second correlation expression. Specifically, the left figure is the same as FIG. 1. That is, in this example, the type and thermal history of the hot-rolled steel sheet are the same as those in the example shown in FIG. 1, and the finally derived first correlation expression is the same as the first correlation expression (linear expression) used to specify the internal oxidation starting temperature Ter. Therefore, the internal oxidation starting temperature Tcr is set to 500° C.

In the right figure, the horizontal axis indicates the coiling completion temperature (° C.), and the vertical axis indicates the cumulative temperature (° C.·min). A point P7 indicates the coiling completion temperature and the cumulative temperature, and a graph L13 indicates a connection of the points P7, that is, the second correlation expression. The cumulative temperature at the point P7 is the cumulative temperature of the center portion. It is assumed that the coiling completion temperature is the temperature of the hot-rolled steel sheet at the time when the coiling of the hot-rolled steel sheet is completed and is uniform on the entire surface of the hot-rolled steel sheet.

Then, the operator determines the coiling completion temperature on the basis of the cumulative temperature corresponding to the thickness of the internal oxide layer, which is equal to or less than a predetermined value, and the second correlation expression such that the thickness of the internal oxide layer estimated by the first correlation expression is equal to or less than the predetermined value.

Specifically, (3) the operator determines the predetermined value of the thickness of the internal oxide layer. In the example shown in FIG. 6, the predetermined value is set to 8 μm. For example, the predetermined value may be determined in consideration of productivity and the like in a pickling step. For example, in the example shown in FIG. 6, in a case in which the coiling completion temperature is 700° C., the thickness of the internal oxide layer is about 11.5 μm. However, when the coiling completion temperature drops to 650° C., the thickness of the internal oxide layer is reduced to about 8 μm. (4) The operator specifies the cumulative temperature corresponding to the thickness of the internal oxide layer which is equal to or less than the predetermined value. In the example shown in FIG. 6, the cumulative temperature is approximately equal to or lower than 40,000° C.·min. (5) The operator specifies the coiling completion temperature corresponding to the cumulative temperature specified in (4). In the example shown in FIG. 6, the coiling completion temperature corresponding to a cumulative temperature of 40,000° C.·min is about 650° C. Therefore, it can be seen that it is necessary to set the coiling completion temperature to 650° C. or lower in order to set the thickness of the internal oxide layer to 8 μm or less. According to this method, it is possible to determine the coiling completion temperature corresponding to the desired thickness of the internal oxide layer with high accuracy. In addition, the operation performed by the operator may be performed by the second correlation expression derivation unit 16. In this case, the operator inputs the desired thickness of the internal oxide layer thickness to the internal oxide layer thickness estimation device 10. The second correlation expression derivation unit 16 may perform the above-described process (performed by the operator) to determine the coiling completion temperature corresponding to the desired thickness of the internal oxide layer.

<7. Internal Oxide Layer Thickness Estimation Method>

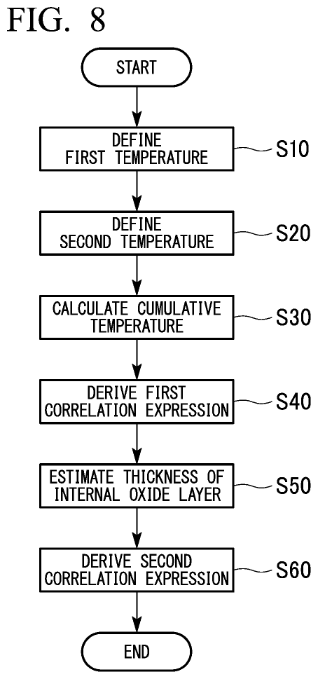

Next, the internal oxide layer thickness estimation method according to this embodiment will be described with reference to a flowchart shown in FIG. 8. In addition, since the detailed process is as described above, only an outline will be described here.

In Step S10, the first temperature definition unit 11 defines the temperature T of the portion to be estimated, in which the thickness of the internal oxide layer is to be estimated, in the hot-rolled steel sheet. The first temperature definition unit 11 derives the temperature T of the portion to be estimated using, for example, the simulation (heat conduction calculation) typified by Non-Patent Document 1.

In Step S20, the second temperature definition unit 12 defines the internal oxidation starting temperature Tcr at which the internal oxidation of the hot-rolled steel sheet is started. The details of the definition are as described in <4. Method for Determining Tcr>. In general, the second temperature definition unit 12 determines (defines) the internal oxidation starting temperature Tcr such that the correlation between the measured value of the thickness of the internal oxide layer and the cumulative temperature is the highest.

In Step S30, the cumulative temperature calculation unit 13 calculates the cumulative temperature of a desired portion to be estimated. The cumulative temperature is defined in Expression (1).

In Step S40, the first correlation expression derivation unit 15 derives the first correlation expression indicating the correlation between the cumulative temperature calculated by the cumulative temperature calculation unit 13 and the estimated value of the thickness of the internal oxide layer. Examples of the first correlation expression include the above-described Expressions (2) to (4).

In Step S50, the internal oxide layer thickness estimation unit 15 estimates the thickness of the internal oxide layer on the basis of the first correlation expression. For example, the internal oxide layer thickness estimation unit 15 applies the cumulative temperature calculated in Step S30 to the first correlation expression to estimate the thickness of the internal oxide layer in the portion. For example, an estimation result may be displayed on the display.

In Step S60, the second correlation expression derivation unit 16 derives the second correlation expression indicating the correlation between the coiling completion temperature of the hot-rolled steel sheet and the cumulative temperature. Then, the second correlation expression derivation unit 16 displays the first correlation expression and the second correlation expression in comparison with each other, for example, as shown in FIG. 6. The operator compares these correlation expressions and determines the coiling completion temperature of the hot-rolled steel sheet such that the thickness of the internal oxide layer is equal to or less than a desired thickness.

As described above, according to the internal oxide layer thickness estimation method of this embodiment, the thickness of the internal oxide layer is estimated using the cumulative temperature having a high correlation with the thickness of the internal oxide layer. Therefore, it is possible to estimate the thickness of the internal oxide layer with high accuracy. Furthermore, according to the method for determining the coiling completion temperature of this embodiment, the coiling completion temperature is determined using the internal oxide layer thickness estimation method. Specifically, the coiling completion temperature is determined such that the thickness of the internal oxide layer estimated by the internal oxide layer thickness estimation method is equal to or less than a predetermined value. Therefore, it is possible to determine the coiling completion temperature corresponding to the desired thickness of the internal oxide layer with high accuracy.

### EXAMPLES

Next, an example of this embodiment will be described. In this example, the following experiments were performed in order to check the effect of this embodiment. Of course, the invention is not limited to the example described below. It is obvious that those skilled in the art to which the invention belongs can conceive of various changes or modification examples within the scope of the technical idea described in the claims. Of course, it is understood that these also fall within the technical scope of the invention.

First, as a test piece of the hot-rolled steel sheet, a steel material containing C: 0.1875%, Si: 0.58%, Mn: 3.25% (the unit of each element is mass % with respect to the total mass (excluding the scale layer) of the test piece of the hot-rolled steel sheet), and a remainder of iron and impurities was prepared. Here, the impurities are components that are mixed due to raw materials, such as ores and scraps, and various factors of a manufacturing step when steel is manufactured industrially and are permissible as long as they do not adversely affect the invention.

Then, the test piece was coiled at a coiling completion temperature of 600° C. and then air-cooled to room temperature. Meanwhile, a plurality of portions on the surface of the test piece were set as the portions to be measured, and the cumulative temperatures of these portions to be measured were derived by the simulation described in Non-Patent Document 1. The internal oxidation starting temperature Tcr was 500° C., the estimation start time t0 was the coiling completion time, and the estimation evaluation time t1 was the time when the temperature T reached the internal oxidation starting temperature Tcr. In addition, in the test piece after cooling, the thickness of the internal oxide layer in the portion to be measured was measured by the above-described method (a cross section was observed after nital etching). As a result, the results shown in FIGS. 3A and 3B were obtained. That is, the point P5 in FIGS. 3A and 3B indicates the cumulative temperature and the measured value of the thickness of the internal oxide layer in each portion to be measured. Therefore, as described above, the first correlation expression indicated by the graphs L11 and L12 or a combination thereof is derived, which makes it possible to estimate the thickness of the internal oxide layer with high accuracy. Furthermore, the coiling completion temperature corresponding to the desired thickness of the internal oxide layer can also be determined by deriving the second correlation expression indicating the correlation between the coiling completion temperature and the cumulative temperature. Further, appropriate manufacturing conditions can be determined by estimating the thickness of the internal oxide layer with high accuracy. For example, the coiling temperature condition in which the thickness of the internal oxide layer is equal to or less than a predetermined value (for example, 8 μm) is optimized to improve the efficiency of the pickling step which is the next step.

The preferred embodiment of the invention has been described in detail above. However, the invention is not limited to the embodiment. It is obvious that those skilled in the art to which the invention belongs can conceive of various changes or modification examples within the scope of the technical idea described in the claims. Of course, it is understood that these also fall within the technical scope of the invention.

### BRIEF DESCRIPTION OF THE REFERENCE SYMBOLS

P1, P2, P5: measurement point indicating cumulative temperature and measured value of thickness of internal oxide layer
P3, P4: measurement point indicating internal oxidation starting temperature and correlation between measured value of thickness of internal oxide layer and cumulative temperature
P7: measurement point indicating coiling completion temperature and cumulative temperature
L1, L4, L5˜L8, L10, L11: graph indicating first correlation expression
L2, L3: graph indicating internal oxidation starting temperature Tcr and correlation between measured value of thickness of internal oxide layer and cumulative temperature
L13: graph indicating second correlation expression
10: internal oxide layer thickness estimation device
11: first temperature definition unit
12: second temperature definition unit
13: cumulative temperature calculation unit
14: first correlation expression derivation unit
15: internal oxide layer thickness estimation unit
16: second correlation expression derivation unit

1. An internal oxide layer thickness estimation device that estimates a thickness of an internal oxide layer formed in a hot-rolled steel sheet, the internal oxide layer thickness estimation device comprising:
a first temperature definition unit that defines a temperature of a portion to be estimated, in which the thickness of the internal oxide layer is to be estimated, in the hot-rolled steel sheet;
a second temperature definition unit that defines an internal oxidation starting temperature at which internal oxidation of the hot-rolled steel sheet starts;
a cumulative temperature calculation unit that calculates a cumulative temperature on the basis of the temperatures defined by the first temperature definition unit and the second temperature definition unit and a predetermined period of time from an estimation start time at which estimation of the thickness of the internal oxide layer is started to an estimation evaluation time;
a first correlation expression derivation unit that derives a first correlation expression indicating a correlation between the cumulative temperature calculated by the cumulative temperature calculation unit and an estimated value of the thickness of the internal oxide layer; and
an internal oxide layer thickness estimation unit that estimates the thickness of the internal oxide layer on the basis of the first correlation expression.

2. The internal oxide layer thickness estimation device according to claim 1,
wherein the internal oxide layer is formed when the hot-rolled steel sheet is cooled in a coiled state.

3. The internal oxide layer thickness estimation device according to claim 1,
wherein the cumulative temperature calculation unit calculates the cumulative temperature on the basis of the following Expression (1):
S_{T}=∫ₜ₀^{t1}(T−Tcr)dt (1)
in Expression (1), S_{T} is the cumulative temperature, T is the temperature of the portion to be estimated, in which the thickness of the internal oxide layer is to be estimated, in the hot-rolled steel sheet, Tcr is the internal oxidation starting temperature at which the internal oxidation of the hot-rolled steel sheet starts, t0 is the estimation start time when the estimation of the thickness of the internal oxide layer is started, t1 is the estimation evaluation time, and T −Tcr is 0 in an integration interval where T−Tcr is equal to or less than 0.

4. The internal oxide layer thickness estimation device according to claim 1,
wherein the first correlation expression is represented by any one or a combination of two or more of the following Expressions (2) to (4):
H=αS_{T}+H₀ (2)
H=βS_{T}^{1/2}+H₀ (3)
H=γS_{T}+δS_{T}²+H₀ (0≤S_{T}≤−γ/(2δ): a local maximum value of the thickness of the internal oxide layer at this time is Hm),
H=φ{S_{T}+γ/(2δ)}+Hm(S_{T}>−γ/(2δ)) (4)
in Expressions (2) to (4), H is the estimated value of the thickness of the internal oxide layer, α, β, γ, φ, and δ are constants, H₀ is an initial value of the thickness of the internal oxide layer, and S_{T} is the cumulative temperature and has a value of S_{T}≥0, and
in a case in which the first correlation expression is configured by Expression (4), in a range of the cumulative temperature after the local maximum value of the thickness of the internal oxide layer, the first correlation expression is set such that at least the estimated value of the thickness of the internal oxide layer is not decreased.

5. The internal oxide layer thickness estimation device according to claim 4,
wherein, in the case in which the first correlation expression is configured by Expression (4), the first correlation expression derivation unit makes the estimated value of the thickness of the internal oxide layer constant at the local maximum value in the range of the cumulative temperature after the local maximum value of the thickness of the internal oxide layer.

6. The internal oxide layer thickness estimation device according to claim 1,
wherein the second temperature definition unit defines the internal oxidation starting temperature on the basis of a correlation between the cumulative temperature and a measured value of the thickness of the internal oxide layer when the internal oxidation starting temperature is changed.

7. The internal oxide layer thickness estimation device according to claim 6,
wherein the second temperature definition unit changes the internal oxidation starting temperature to derive a temperature-determining correlation expression indicating a correlation between the cumulative temperature and the estimated value of the thickness of the internal oxide layer and defines the internal oxidation starting temperature on the basis of a degree-of-freedom determination coefficient R² of the temperature-determining correlation expression.

8. The internal oxide layer thickness estimation device according to claim 1,
wherein the hot-rolled steel sheet is coiled, and
the estimation start time is a coiling completion time at which the coiling of the hot-rolled steel sheet is completed.

9. The internal oxide layer thickness estimation device according to claim 1, further comprising:
a second correlation expression derivation unit that derives a second correlation expression indicating a correlation between the cumulative temperature and a coiling completion temperature of the hot-rolled steel sheet.

10. An internal oxide layer thickness estimation method that estimates a thickness of an internal oxide layer formed in a hot-rolled steel sheet, the internal oxide layer thickness estimation method comprising:
a first temperature definition step of defining a temperature of a portion to be estimated, in which the thickness of the internal oxide layer is to be estimated, in the hot-rolled steel sheet;
a second temperature definition step of defining an internal oxidation starting temperature at which internal oxidation of the hot-rolled steel sheet starts;
a cumulative temperature calculation step of calculating a cumulative temperature on the basis of the temperatures defined by the first temperature definition step and the second temperature definition step and a predetermined period of time from an estimation start time at which estimation of the thickness of the internal oxide layer is started to an estimation evaluation time;
a first correlation expression derivation step of deriving a first correlation expression indicating a correlation between the cumulative temperature calculated by the cumulative temperature calculation step and an estimated value of the thickness of the internal oxide layer; and
an internal oxide layer thickness estimation step of estimating the thickness of the internal oxide layer on the basis of the first correlation expression.

11. A non-transitory computer readable medium storing a program that causes a computer to estimate a thickness of an internal oxide layer formed in a hot-rolled steel sheet,
the program causing the computer to function as:
a first temperature definition unit that defines a temperature of a portion to be estimated, in which the thickness of the internal oxide layer is to be estimated, in the hot-rolled steel sheet;
a second temperature definition unit that defines an internal oxidation starting temperature at which internal oxidation of the hot-rolled steel sheet starts;
a cumulative temperature calculation unit that calculates a cumulative temperature on the basis of the temperatures defined by the first temperature definition unit and the second temperature definition unit and a predetermined period of time from an estimation start time at which estimation of the thickness of the internal oxide layer is started to an estimation evaluation time;
a first correlation expression derivation unit that derives a first correlation expression indicating a correlation between the cumulative temperature calculated by the cumulative temperature calculation unit and an estimated value of the thickness of the internal oxide layer; and
an internal oxide layer thickness estimation unit that estimates the thickness of the internal oxide layer on the basis of the first correlation expression.
